(19) United States
(12) Patent Application Publication
(10) Pub. No.: US 2007/0033946 A1
(43) Pub. Date: Feb. 15, 2007

(54) Helicopter defense system and method

(76) Inventor: Leonard M. Greene, Mamaroneck, NY (US)

Correspondence Address: David E. Dougherty;DENNISON, SCHULTZ, DOUGHERTY & MACDONALD, Suite 105, 1727 King Street, Alexandria, VA, 22314, US

(21) Appl. No.: 11/199,267

(22) Filed: Aug. 9, 2005

(51) Int. Cl. F02C 3/30

(52) U.S. Cl. 60/775; 60/39.5

(57) ABSTRACT

A method and system for aiding a helicopter pilot to avoid being struck by a heat seeking missile includes the steps of providing a mass of water and a missile detector for detecting an incoming heat seeking missile. The water is contained in a tank that extends around an exhaust housing and is adapted to eject water onto and into the housing. The cooling water is ejected out of the tank and into the exhaust housing to thereby cool the exhaust and disrupt the guidance system of an incoming missile.

### FIELD OF THE INVENTION

This invention relates to a missile defense system for helicopters and methods for evading heat seeking missiles and more particularly to methods and systems for reducing exhaust and engine temperature.

### BACKGROUND FOR THE INVENTION

Representatives of the U.S. government, the airline industry and aircraft pilots recognize that terrorists may attempt to fire a surface to air missile such as a man-portable air defense system (MANPADS) at a commercial or civil aircraft. As reported in an International Federation of Airline Pilot's Association, and Security Bulletin of 31 Mar. 2003, the FAA issued a notice that states in part that there is no credible evidence that terrorists have smuggled MANPADS into the United States. Nevertheless, the potential for such a threat does exist. The threat is exacerbated by a large number of unaccounted for MANPADS many of which may be in the hands of terrorist organizations.

In view of the threat, the Department of Homeland Security on Oct. 3, 2003 issued a solicitation RA-02 for a Counter-Man-Portable Air Defense System. As reported therein, the Department of Homeland Security “is initiating a program for the development of an anti missile device for commercial aircraft.” The Department of Homeland Security also identified an on-board jamming (directed infrared counter measure (DIRCM) as the most promising existing technology which is capable of good performance against the current and emerging threats while potentially satisfying operational constraints.

Then on Jan. 7, 2004, the Washington Post reported that “the Department of Homeland Security which has identified shoulder fired missiles as threats to commercial aircraft, chose three companies to develop anti missile technology.” As reported, the government proposal calls for adapting military technology to commercial planes—a concept of which many are skeptical.

There are serious problems associated with adopting military technology to commercial aircraft. For example, the cost for equipping each aircraft has been estimated to be about 5 million dollars. Further, the cost for equipping 6,800 plus commercial jets with such systems has been estimated at between 7 to 10 billion dollars. Even at that cost, corporate jet and other non-commercial aircraft would be unprotected.

An additional problem with military technology relates to the deployment of flares to divert a heat seeking missile. The deployment of flares over heavily populated areas could cause fires and/or death on the ground. Further, there is little or no need to protect the aircraft at altitudes beyond the range of present day or envisioned man-portable or shoulder launched surface to air missiles.

Helicopters are flown at relatively low altitudes and relatively slow speeds and are particularly vulnerable to an attack from a shoulder fired ground to air missile. Therefore, there is a need for an improved helicopter defense system and method in accordance with the present invention. In addition, such systems and methods should avoid problems relating to the deployment of pyrotechnic flares, are relatively inexpensive, durable, reliable and readily installed on many if not most helicopters.

It is now believed that a pilot of an airborne helicopter may be able to avoid being struck by a heat seeking missile by a method and/or system in accordance with the present invention. The method involves the steps of providing a missile detection system and a mass of coolant, and upon detection of a heat seeking missile such as detecting “lock-on” the method includes the immediate or almost immediate injection of coolant into or onto an exhaust duct to cool the exhaust and thereby disrupt a missile's guidance system. After that, the pilot continues his flight pattern or takes evasive action.

### BRIEF SUMMARY OF THE INVENTION

In essence, the present invention contemplates a method and system for aiding an airborne pilot of a helicopter to avoid being struck by a heat seeking missile. The method includes the step of providing a missile detection system that detects a “lock-on” by a heat seeking missile. Such systems are well known and used in military aircraft and are considered to be conventional.

The method also includes the step of providing a mass of coolant such as water in close proximity to the engine as for example about the engine. Then when the missile detection system detects a “lock-on” or incoming missile, a mass of coolant is immediately or almost immediately ejected onto and/or into the exhaust duct creating a cloud of steam to thereby rapidly cool the exhaust and/or the exhaust area of the engine to thereby confuse the guidance system of the missile. After this step, a pilot continues on course or elects to change course.

A second embodiment of the invention contemplates a system which includes a missile detector and water dispenser. The missile detector is any of the well known military types for detecting incoming missiles while the water storage and ejection means contains a mass of water and means such as compressed gas for injecting a mass of water onto and/or into the exhaust duct to cool the exhaust and thereby disrupt a missile's guidance system. It should be recognized that in this case a mass of water is preferably injected as opposed to a spray so that the water is almost immediately converted to steam by the high temperature of the exhaust which results in rapid cooling of an area around the engine.

The invention will now be described in connection with the accompanying drawings.

### BRIEF DESCRIPTION OF THE DRAWINGS

FIG. 1 is a schematic illustration of a missile defense system in accordance with the present invention; and

FIG. 2 is a block diagram illustrating a second embodiment of the invention.

### DESCRIPTION OF THE PREFERRED EMBODIMENT OF THE INVENTION

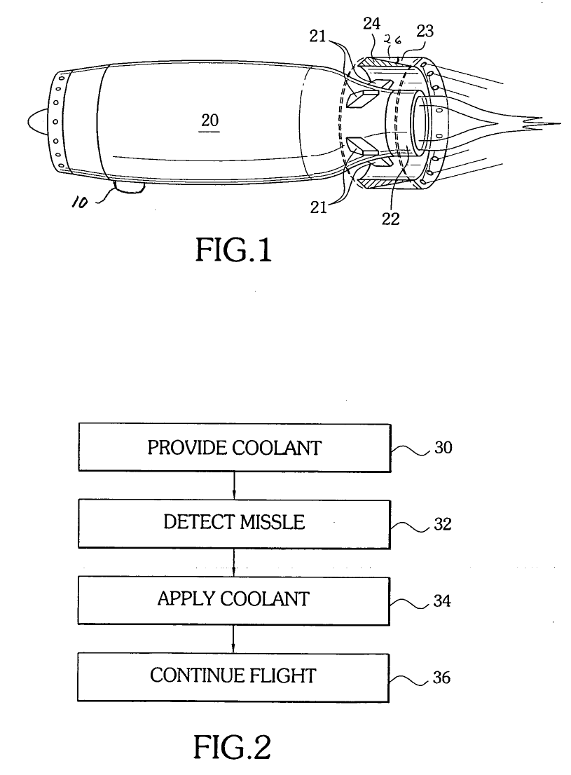

A missile defense system in accordance with a first embodiment of the invention is illustrated in FIG. 1. As shown, the system includes means such as a detector 10 for detecting a heat seeking missile that is aimed at the aircraft. The detector 10 is of a conventional design as used on military aircraft and triggers an immediate or almost immediate response upon detection of the missile.

A key element in the present system resides in means for ejecting a mass of coolant such as water onto and/or into an exhaust housing 22 of an engine 20. For example, the engine 20 includes a second or outer housing 24 that extends around the exhaust housing 22 and may extend beyond the back of the exhaust housing 22 so that a mass of water contained in a tank 23 can be ejected onto and/or into the exhaust housing to rapidly cool or essentially quench the hot exhaust. As illustrated schematically a source of compressed gas 26 or other means is used to force the mass of water out of the tank 23 and onto and/or into the exhaust housing 22. The outer housing 24 extends around the exhaust housing 22 and is mounted on the helicopter engine by a plurality of supports 21. The electronics for immediate actuation of the water quench are similar to the electronics for activating other missile defense systems and are considered to be conventional or well within the ability of a person of ordinary skill in the art.

The invention also contemplates a method for aiding a helicopter to avoid being struck by a heat seeking missile as illustrated in FIG. 2. As illustrated, the method includes the step 30 of providing a mass of coolant for rapidly cooling an engine exhaust and a detector for detecting a heat seeking missile that is aimed at the helicopter. The detector detects an incoming missile in step 32 as for example by detecting a “lock-on” in a conventional manner. Immediately upon detection of an incoming missile, a mass of coolant such as water is ejected onto and/or into the exhaust housing of the engine in step 34. The water is converted to steam and rapidly drops the temperature of the exhaust to disrupt the missile guidance system.

The mass of water needed to cool the exhaust may vary from aircraft to aircraft but it is presently believed that six to ten gallons may be sufficient. Actual amounts can be readily determined by physical testing and/or computer analysis.

Following the water injection, the aircraft continues on its course in step 36 or may take other evasive or defensive action.

While the invention has been described in connection with its preferred embodiments, it should be recognized that changes and modifications may be made therein without departing from the scope of the appended claims.

What is claimed is:

1. A helicopter missile defense system comprising means for detecting a heat seeking missile, an engine having an exhaust duct, and means for storing a mass of coolant and for ejecting a mass of coolant onto and/or into said exhaust duct to cool the exhaust and thereby disrupt a missile's guidance system.

2. A helicopter missile defense system according to claim 1, in which the mass of coolant is water.

3. A helicopter missile defense system according to claim 2, in which said means for ejecting a mass of water is constructed and arranged to eject water onto and/or into said duct from a plurality of positions around said engine.

4. A helicopter missile defense system according to claim 2, in which a helicopter engine includes a housing around said exhaust duct and in which said housing includes means for storing a mass of water for cooling the engine's exhaust.

5. A helicopter missile defense system according to claim 2, in which said means for ejecting a mass of water includes a compressed gas.

6. A method for aiding a helicopter to avoid being struck by a heat seeking missile comprising the steps of:
providing a mass of coolant and a detector for detecting an incoming heat seeking missile;
detecting an incoming heat seeking missile;
immediately ejecting a mass of water into and/or onto an exhaust duct of a helicopter engine to thereby cool a helicopter's exhaust and disrupt a missile's guidance system.
